(19) United States
(12) Patent Application Publication
(10) Pub. No.: US 2008/0088827 A1
(43) Pub. Date: Apr. 17, 2008

(54) METHOD AND APPARATUS OF MONITORING PLASMA PROCESS TOOL

(75) Inventors: SHING-ANN LUO, HSINCHU (TW); TUNNG LUOH, HSINCHU (TW); CHIN-TA SU, HSINCHU (TW); KUNG-CHAO CHEN, HSINCHU (TW)

Correspondence Address: J C PATENTS, INC., 4 VENTURE, SUITE 250, IRVINE, CA, 92618, US

(73) Assignee: MACRONIX INTERNATIONAL CO., LTD., HSINCHU (TW)

(21) Appl. No.: 11/550,282

(22) Filed: Oct. 17, 2006

(51) Int. Cl. G01N 21/00; G01J 3/00

(52) U.S. Cl. 356/72; 356/300

(57) ABSTRACT

A method of monitoring a plasma process tool is provided, which includes obtaining a spectrum of a film to be detected from the plasma process tool, and then analyzing the spectrum by integrating a function of the spectrum intensity which focuses on specific or desired wavelength range, thereby determining whether the spectrum is abnormal from a obtained value. Since the film to be detected is detected after depositing the film in the plasma process tool, and therefore the film with a desired quality may be obtained.

### BACKGROUND OF THE INVENTION

1. Field of the Invention

The present invention relates to a method for plasma process application, and more particularly, to a method and an apparatus capable of monitoring a plasma process tool in real time.

2. Description of Related Art

Deposition process has become one of the most important processes for manufacturing semiconductor device. All of the films required by a semiconductor device, including conductors, semiconductors, or dielectrics, may be formed using deposition process. The so-called “plasma deposition process” has become one of the main thin film deposition processes, such as, plasma-enhanced chemical vapor deposition (PECVD) or high density plasma (HDP) CVD that is commonly used at present. Generally, in a plasma deposition chamber, different material layers can be obtained through changing the parameters of different plasma process tools.

However, due to the instability of the plasma process tool, the plasma deposition process cannot be monitored through the existing measurement methods to detect any abnormal conditions until a whole semiconductor device has been manufactured. Thus, this not only increases the manufacturing cost but also waste a lot of time and material.

Therefore, a method and an apparatus for monitoring the stability of the plasma process tool in real time are highly desirable, and preferably the method and apparatus may be widely applied in monitoring the plasma process.

### SUMMARY OF THE INVENTION

One objective of the present invention is to provide a method of monitoring a plasma process tool, so as to determine whether the plasma process tool is abnormal or not in real time.

Another objective of the present invention is to provide a method of protecting a semiconductor device from being damaged due to an abnormal plasma process condition.

Still another objective of the present invention is to provide a method of monitoring the repeatability and stability of a lot of chips during a plasma process, such that the lot of chips or more are readily monitored, thereby early preventing the issue during wafer acceptance test (WAT).

Still another objective of the present invention is to provide a method of monitoring a film deposited through a plasma process, so as to monitor the quality of the deposited film in real time.

Yet another objective of the present invention is to provide an apparatus for monitoring a plasma process tool, so as to obtain the stability and repeatability of the plasma process tool in real time. The apparatus may be used for various monitor operations.

The present invention provides a method of monitoring a plasma process tool, comprising obtaining a spectrum of a film to be detected from the plasma process tool and then analyzing the spectrum by integrating a function of the spectrum intensity which focuses on specific or desired wavelength range, thereby determining whether the spectrum is abnormal from a obtained value.

According to an embodiment of the present invention, the process of obtaining the spectrum of the film to be detected is implemented by utilizing a plasma detect system (PDS).

The method of monitoring a plasma process tool according to one embodiment of the present invention further comprises specifying a limited range for the plasma process tool in advance so that if the spectrum of the film to be detected is determined to be abnormal, it is regarded as exceeding the specified limited range, and accordingly a warning signal may sent out to notify the designer/operator.

The method of monitoring a plasma process tool according to one embodiment of the present invention further comprises adjusting the operation parameters of the plasma process tool according to result of the spectrum analysis.

The present invention further provides a method of protecting a semiconductor from being damaged comprising: providing a plurality of films manufactured in a plasma process tool through different plasma processes respectively, wherein the films are made of one material with a slightly different proportion of elements; obtaining a plurality of spectrums of each film from the plasma process tool and analyzing the spectrums of each of the films by comparing the spectrum intensity which focuses on a short wavelength range so as to determine a selected spectrum having a relatively low spectrum intensity compared to that of the remaining spectrums of each of the films; and adopting a plasma process corresponding to the selected spectrum to deposit the film made of the material.

In the method of protecting a semiconductor from being damaged according to one embodiment of the present invention, the selected spectrum has a lowest spectrum intensity compared to the spectrums of each of the films within a short wavelength range.

In the method of protecting a semiconductor device from being damaged according to one embodiment of the present invention, the process of obtaining the spectrums of each film is implemented by utilizing a PDS.

The present invention further provides a method of monitoring the quality of a lot of chips comprising: obtaining a plurality of spectrums of one lot of chips from a plasma process tool; and comparing the spectrums so as to monitor their stability and repeatability.

In the method of monitoring the quality of a lot of chips according to an embodiment of the present invention, the step of comparing the spectrums comprises selecting a wavelength range and comparing the spectrum intensity of each of the chips of this lot within the selected wavelength range.

In the method of monitoring the quality of a lot of chips according to an embodiment of the present invention, the lot of chips represent the chips being performed by the same program.

In the method of monitoring the quality of a lot of chips according to one embodiment of the present invention, the process of obtaining the spectrums of the lot of chips is implemented by utilizing a PDS.

The present invention further provides a method of monitoring a film deposited through a plasma process comprising: providing a standard film; obtaining a spectrum of the standard film; performing a plasma process in a plasma process tool to deposit a film; obtaining the spectrum of the film from the plasma process tool; and comparing and analyzing the spectrum of the film with that of the standard film so as to determine whether the film meets the standard.

According to an embodiment of the present invention, if the standard film has a reflection index, a refractive index (RI, also called value n), and an extinction coefficient (also called value k) within a predetermined range, when the film to be detected is determined not to meet the standard. Therefore, it is required that at least one of the reflection index or the value n and the value k of the standard film should exceed the predetermined range in order to meet the standard.

According to an embodiment of the present invention, the process of obtaining the spectrum of the standard film is accomplished utilizing a PDS.

According to an embodiment of the present invention, the process of obtaining the spectrum of the film to be detected is accomplished utilizing a PDS.

The present invention further provides a method of determining whether a semiconductor device is damaged during a plasma process comprising: providing several chips; forming a film to be detected on each of the chips, wherein the film to be detected is manufactured in an identical plasma process tool through the same plasma process; obtaining the spectrum of the film to be detected on each of the chips from the plasma process tool; and comparing the spectrums of each film to be detected so as to find an abnormal spectrum, wherein the film having the abnormal spectrum is damaged during the plasma process due to an abnormal temperature of the chip.

According to an embodiment of the present invention, the process of obtaining the spectrums of each film to be detected is implemented by utilizing a PDS.

According to an embodiment of the present invention, the plasma process tool includes a high density plasma (HDP) tool.

The present invention further provides a method of determining a timing of open-chamber clean of a plasma process tool, comprising: obtaining a spectrum from an internal wall of a vacuum chamber of the plasma process tool during a designated time period; and determining the timing of open-chamber clean of the plasma process tool based on decreases in the spectrum intensity of the obtained spectrum.

According to an embodiment of the present invention, the process of obtaining the spectrum of the internal wall of the vacuum chamber of the plasma process tool is implemented by utilizing a PDS.

According to an embodiment of the present invention, the plasma process tool includes a HDP tool.

The present invention further provides an apparatus for monitoring a plasma process tool comprising a PDS and an analysis device. Wherein, the PDS is used to obtain the spectrum of a film to be detected in the plasma process tool, and the analysis device is used to receive and then analyze the spectrum obtained from the PDS, so as to determine whether or not the film to be detected meets the standard.

According to an embodiment of the present invention, the PDS at least comprises a broadband spectrum controller and an optical fiber, wherein the optical fiber is used to transmit a spectral signal of the film to be detected to the broadband spectrum controller.

According to an embodiment of the present invention, the analysis device includes a computer.

According to an embodiment of the present invention, the plasma process tool includes a high density plasma (HDP) tool.

The advantages of the present invention lie in that the spectrum of a film to be detected is obtained from a plasma process tool in real time, such that the stability of the process ensured by monitoring and controlling the spectrum, and this spectrum is regarded as a feature and a factor to monitor the parameter and the repeatability of the process. Furthermore, whether or not the characteristic of the deposited film varies may be determined by determining the spectrum intensity.

In order to make aforementioned and other objects, features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of an apparatus for monitoring a plasma process tool according to a first embodiment of the present invention.

FIG. 2 is a flowchart illustrating the process steps of a method for monitoring a plasma process tool according to a second embodiment of the present invention.

FIG. 3 is a flowchart illustrating the process steps of a method of protecting a semiconductor device from being damaged according to a third embodiment of the present invention.

FIG. 4 is a flowchart illustrating the process steps of a method of monitoring the repeatability and stability of a lot of chips during a plasma process according to a fourth embodiment of the present invention.

FIG. 5 is a flowchart illustrating the process steps of a method for monitoring the film deposited through a plasma process according to a fifth embodiment of the present invention.

FIGS. 6A-6C are spectrums and curve diagrams for verifying the feasibility of the fifth embodiment of the present invention.

FIG. 7 is a flowchart illustrating the process steps of a method for determining whether a semiconductor device is damaged during the plasma process according to a sixth embodiment of the present invention.

FIG. 8 is a flowchart illustrating the process steps of a method for determining a timing of open-chamber clean of a plasma process tool according to a seventh embodiment of the present invention.

### DESCRIPTION OF EMBODIMENTS

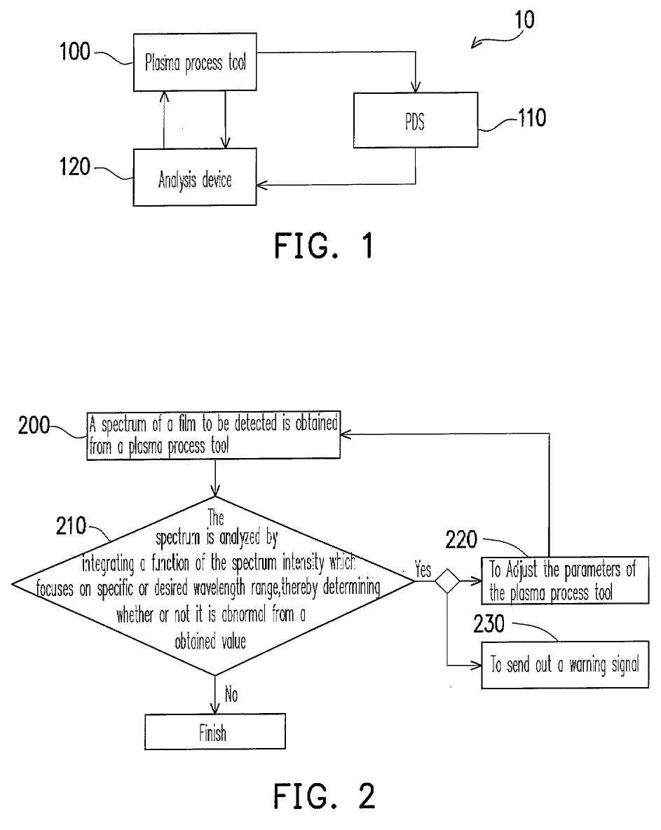

FIG. 1 is a block diagram of an apparatus for monitoring a plasma process tool according to a first embodiment of the present invention.

Referring to FIG. 1, in the first embodiment, the apparatus 10 for monitoring a plasma process tool comprises a plasma detect system (PDS) 110 and an analysis device 120, wherein the PDS 110 is used to obtain the spectrum of a film to be detected in a plasma process tool 100. Particularly, the film to be detected is detected in the plasma process tool 100 as soon as the plasma process is performed, so as to obtain desired data in real time. The analysis device 120 receives and analyzes the spectrum from the PDS 110 to determine whether the film to be detected meets a standard. For example, this analysis may be integrating a function of the spectrum intensity which focuses on specific or desired wavelength range, thereby determining whether the film is abnormal from a obtained value. The PDS 110 may be any apparatus that can be used to obtain the spectrum of the film to be detected in the plasma process tool 100. For example, the PDS 110 at least comprises a broadband spectrum controller and an optical fiber, wherein the optical fiber is used to transmit a spectral signal of the film to be detected to the broadband spectrum controller.

Referring to FIG. 1, the above analysis device 120 includes a computer, and the plasma process tool 100 includes a high density plasma (HDP) tool or any other equivalent tool suitable for using plasma. When the analysis device 120 determines that the film to be detected is abnormal, the parameter of the plasma process tool 100 may be adjusted for making corrections. Alternatively, a predetermined range may be specified in advance in the analysis device 120 according to the limitation of the plasma process tool 100 such that when the spectrum obtained by the PDS 110 exceeds the predetermined range, the analysis device 120 sends out a warning signal.

According to the first embodiment of the present invention, since the data of the broadband spectrum may be collected in real time via the optical fiber and then analyzed by the analysis device. Thus, the apparatus in the first embodiment of the present invention may serves as a tool to control the stability of the plasma process.

Various monitoring methods may be applied in the apparatus of the present invention. Some embodiments are listed below for illustration, but not intend to limit the application scope of the present invention.

FIG. 2 is a flowchart illustrating the process steps of a method for monitoring a plasma process tool according to a second embodiment of the present invention.

Referring to FIG. 2, first, at Step 200, a spectrum of a film to be detected is obtained from a plasma process tool, wherein the plasma process tool may include an HDP tool and the spectrum of the film to be detected may obtained using, for example, a PDS. And, the film to be detected, for example, is just finished a plasma deposition process by utilizing the plasma process tool.

Next, at Step 210, the spectrum is analyzed by integrating a function of the spectrum intensity which focuses on specific or desired wavelength range, thereby determining whether or not it is abnormal from a obtained value. If the spectrum is determined to be normal, the monitoring process is ended.

On the contrary, if the spectrum is determined to be abnormal, Step 220 is performed for adjusting the parameters of the plasma process tool to make correction. Otherwise, since a limited range has already been specified for the plasma process tool, and when the spectrum of the film is abnormal, the film is regarded to exceed the specified range, and Step 230 may be directly performed after the Step 210 to send out a warning signal to notify the designer or the operator.

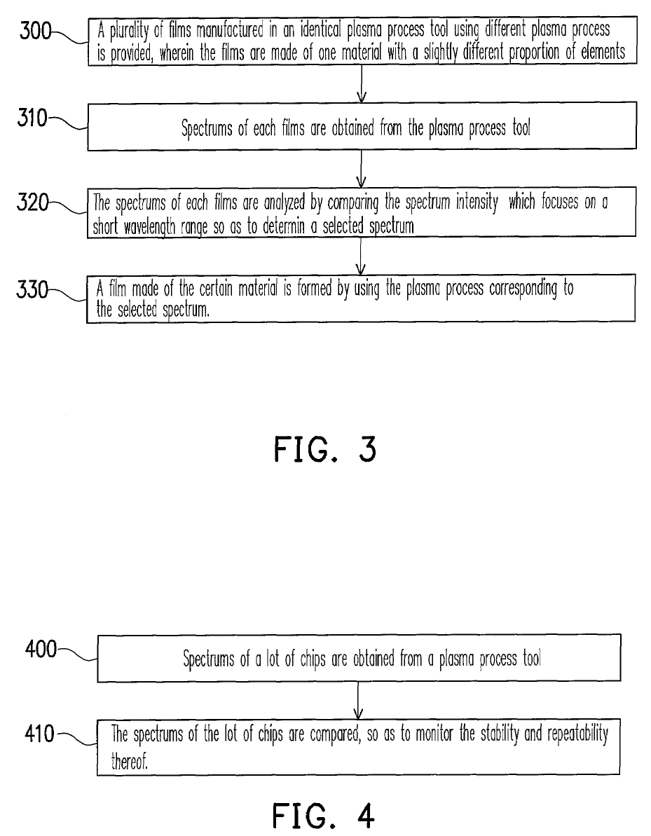

FIG. 3 is a flowchart illustrating the process steps of a method for protecting a semiconductor device according to a third embodiment of the present invention.

Referring to FIG. 3, first, at Step 300 a plurality of films manufactured in an identical plasma process tool using different plasma processes is provided. The films are made of one material with a slightly different proportion of elements, and the plasma process tool includes an HDP tool. For example, the films include various material layers of a semiconductor device, such as an oxide layer for serving as a gate dielectric layer or nitride layer.

Next, at Step 310, spectrums of each film are obtained from the plasma process tool, wherein the spectrums may be obtained using, for example, a PDS.

Next, at Step 320, the spectrums of each film are analyzed by comparing the spectrum intensity which focuses on a short wavelength range e.g. a UV light wavelength range so as to determine a selected spectrum. The selected spectrum has a relatively low spectrum intensity compared to that of the remaining spectrums of each of the films, and the selected spectrum preferably has a lowest spectrum intensity compared to the spectrums of each of the films within the short wavelength range, For example, upon research, it is found that the performance of a gate oxide layer commonly used in a semiconductor device is influenced by the problem of plasma damage, when its electron energy is greater than 3.2 eV. Therefore, upon calculation, it is known that the spectrum intensity within a wavelength (λ) of about 400 nm significantly influences the gate oxide layer, and therefore the wavelength of about 400 nm may used as a basis for selection.

Next, at Step 330, a film made of the certain material is formed by using the plasma process corresponding to the selected spectrum. As such, since the plasma process that causes high spectrum intensity that may form damaged film is avoided, and therefore the possibility of forming damaged devices due to damaged film may be avoided. Thus, a semiconductor device may be protected from being damaged due to abnormal plasma process.

Furthermore, according to the existing standard and actual demands, some parameters of the plasma deposition process are selected as standard, and then according to the method described above, the parameter with the lowest damage to the film is selected as an optimal process parameter. Therefore, based on the architecture of selecting and determining the process parameters, the method provided by the present invention additionally serves as a method of determining the plasma process parameter, so as to avoid the film damage, thereby eliminating the disadvantages of the prior art.

FIG. 4 is a flowchart illustrating the process of steps of monitoring the repeatability and stability of a lot of chips during a plasma process according to a fourth embodiment of the present invention.

Referring to FIG. 4, first, at Step 400, spectrums of the lots of chips are obtained from a plasma process tool, wherein the plasma process tool includes an HDP tool. And, the so-called lot of chips in this embodiment further represent the chips being performed by the same program. The spectrums of the lot of chips are obtained using, for example, a PDS.

Next, at Step 410, the spectrums of the lot of chips are compared, so as to monitor the stability and repeatability thereof. That is, the stability of the plasma process for forming the lot of chips is detectable. Furthermore, the process of comparing the spectrums of the lot of chips comprises: for example, first, selecting a wavelength range, and comparing the spectrum intensity of each chip of the lot of chips falling within the wavelength range. If there are abnormal spectrums in the lot of chips such as abnormal high spectrum intensity, the abnormal spectrums are individually analyzed in order to determine the core cause of the problems and accordingly solve the problems within a short time.

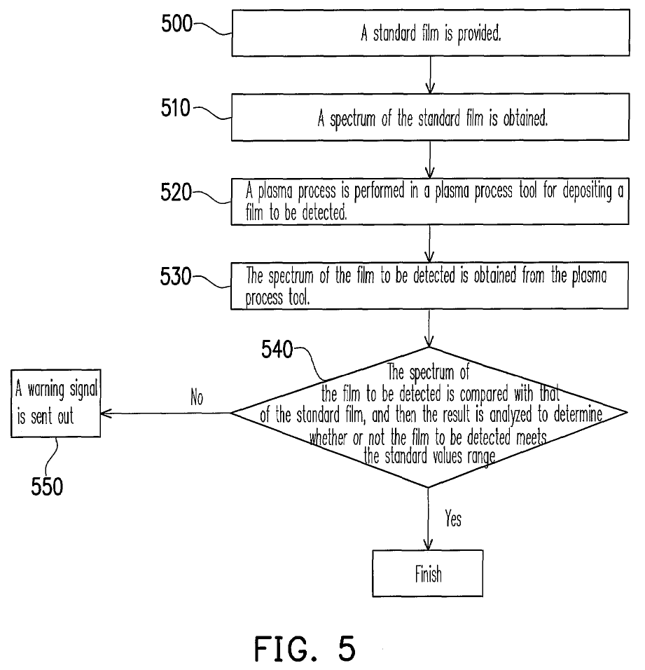

FIG. 5 is a flowchart illustrating the process steps for monitoring the film deposited through a plasma process according to a fifth embodiment of the present invention.

Referring to FIG. 5, first, at Step 500, a standard film is provided. The standard film has, for example, a reflection index, a refractive index (RI, also called value n), and an extinction coefficient (also called value k), or any other value that serves as a standard value, and the limited ranges of these values are specified as a standard values range. The standard values range are easily appreciated by those of ordinary skills in the art and which, thus, will not be described herein any longer.

Next, at Step 510, a spectrum of the standard film is obtained, and thus a spectrum intensity thereof is obtained. The spectrum of the standard film may be obtained using, for example, a PDS.

Next, at Step 520, a plasma process is performed in a plasma process tool for depositing a film to be detected, wherein the plasma process tool includes an HDP tool.

Next, at Step 530, the spectrum of the film to be detected is obtained from the plasma process tool, wherein the spectrum of the film to be detected may be obtained using, for example, a PDS.

Next, at Step 540, the spectrum of the film to be detected is compared with that of the standard film, and then the result is analyzed to determine whether the film to be detected meets the standard values range. The analysis includes, for example, comparing the spectrum intensity of the film to be detected with that of the standard film to obtain the difference. If the difference is not significant, the film to be detected is determined to meet the standard values range and the monitoring process is ended.

However, if the spectrum intensity of the film to be detected is determined to significantly differ from that of the standard film, the film to be detected is determined as not meeting the standard values range. For example, it is derived that, for example, at least one of the reflection index or the value n and the value k exceeds the aforementioned standard values range, and in the subsequent Step 550, a warning signal is sent out to warn the designer of operator so that the designer or the operator may adjust the parameters of the plasma process to correct the problems so as to obtain a film that meets the standard values range, or discard the film to be detected, thereby facilitating the reworking.

As described above, according to the fifth embodiment of the present invention, whether the deposited film falls within the standard values range can be determined without individually detecting the values of the reflection index, the value n, and the value k.

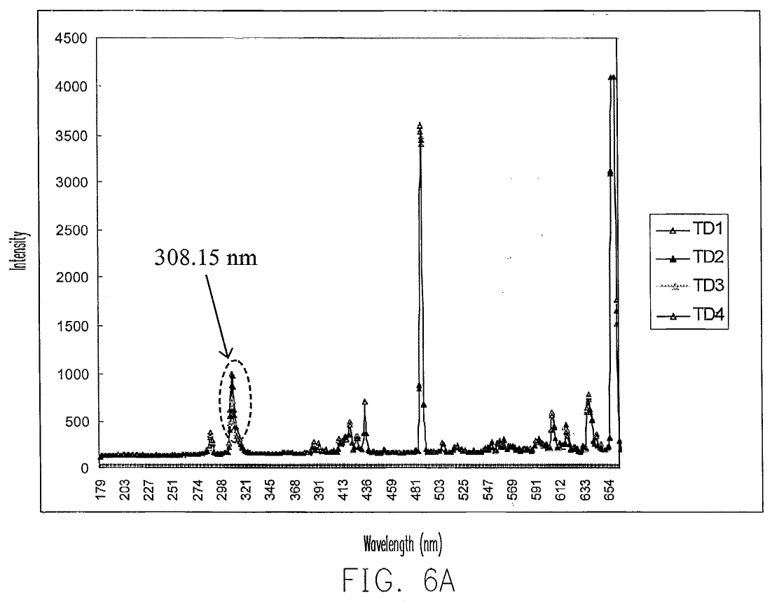

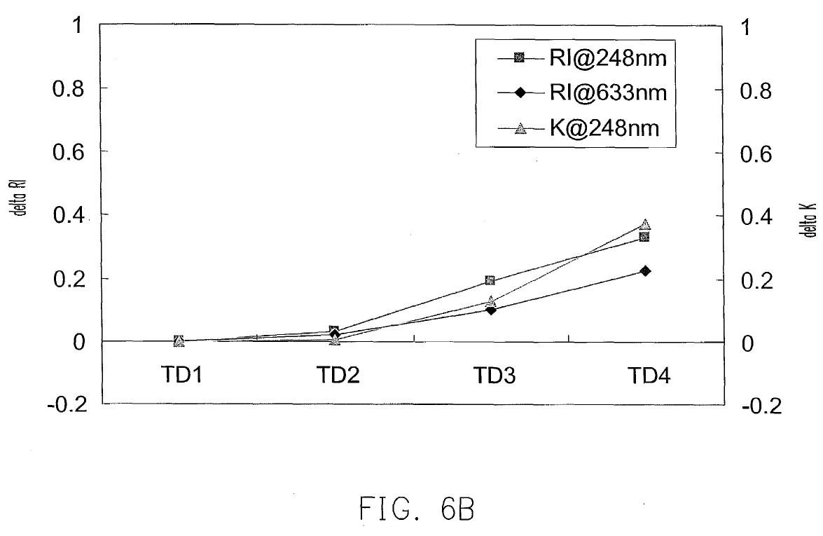

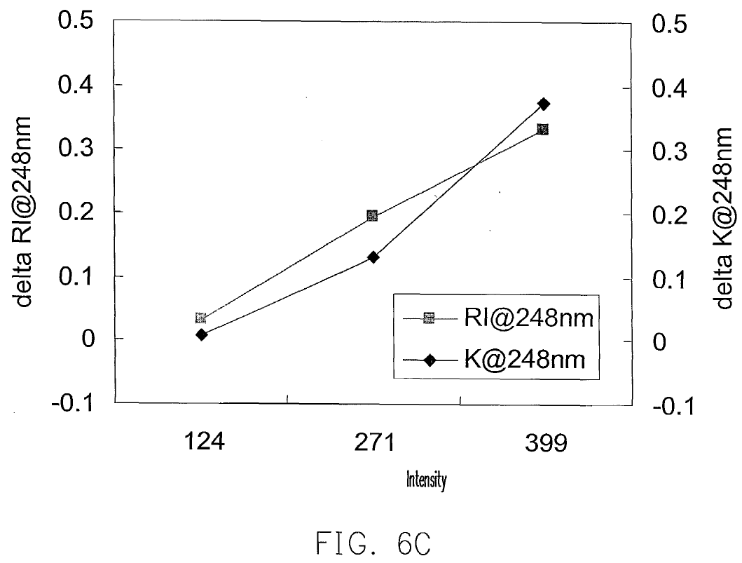

FIGS. 6A-6C are spectrum and curve diagrams for verifying the feasibility of the fifth embodiment of the present invention.

Referring to FIG. 6A, the spectrum of a film deposited utilizing plasma including SiH₄ gas is obtained, wherein the flow rate of SiH₄ is varied and those of other gases are fixed. TD1, TD2, TD3, and TD4 represent different SiH₄ gas flow rates including 93 sccm, 103 sccm, 113 sccm, and 123 sccm respectively. The plasma gas may also include O₂ at a flow of 155 sccm and Ar at a flow rate of 390 seem, and plasma process condition may include LF of 3500 Hz, HF of 2650 Hz and DT=78s. As can be seen from the diagram that when the ratio of SiH₄/O₂ increases from 0.6 to 0.8, the spectrum intensity is obviously changed under the wavelength of 305.8 nm. Furthermore, FIG. 6A only provides a simplified illustration and does not show the spectrum intensity at the wavelength of greater than 654 nm. However, in fact, the spectrum intensity under several specific wavelengths greater than 654 nm is also obviously changed. Therefore, the so-called spectrum wavelength of the present invention substantially falls within the spectrum range from UV light to visible light range (all spectral range).

FIG. 6B shows that film characteristics of different reflection indices (RI, also called the n value) and extinction coefficients (the value k) may be achieved from different gas ratios. For example, as shown in FIG. 6B, the values RI are changed at SiH₄ flow rates TD1, TD2, TD3, and TD4. As for the value k, it is also changed at SiH₄ flow rates TD1, TD2, TD3, and TD4. In view of the above, referring to FIGS. 6A and 6B, it is proved that the difference between the value n and the value k is indicated by the spectrum intensity under a specific wavelength.

Therefore, as shown in FIG. 6C, the SiH₄ flow rate TD1 is selected as a baseline and the spectrum peak intensity difference obtained under the wavelength of 308.15 nm according to various flow rates TD1, TD2, TD3, and TD4 can be used as the spectrum intensity for monitoring the characteristics of the film, such as the value n and the value k. If the spectrum intensity is changed, the quality of the film is changed accordingly, and the objective (RI. k) may be achieved by modifying the process parameters.

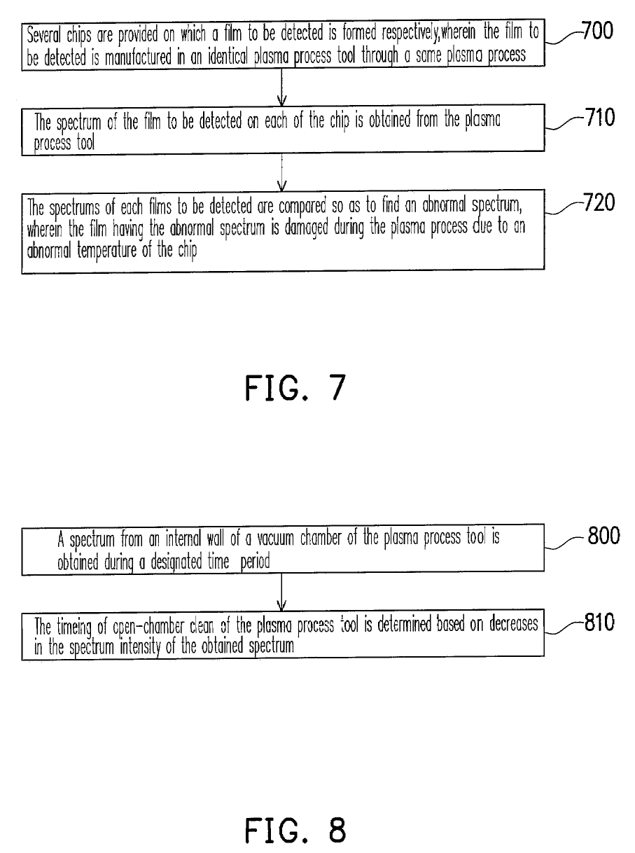

FIG. 7 is a flowchart illustrating the process steps of a method for determining whether a semiconductor device is damaged during the plasma process according to a sixth embodiment of the present invention.

Referring to FIG. 7, at Step 700 several chips are provided. A film to be detected is formed on each of the chips respectively, wherein the film to be detected is manufactured in an identical plasma process tool through a same plasma process. The plasma process tool may include an HDP tool, for example.

Next, at Step 710, the spectrum of the film to be detected on each of the chips is obtained from the plasma process tool, wherein the spectrum of the film to be detected on each of the chips may be obtained by using, for example, a PDS.

Next, at Step 720, the spectrums of each film to be detected are compared so as to find an abnormal spectrum, wherein the film having the abnormal spectrum is damaged during the plasma process due to an abnormal temperature of the chip.

FIG. 8 is a flowchart illustrating the process steps of a method for determining a timing of open-chamber clean of a plasma process tool according to a seventh embodiment of the present invention.

Referring to FIG. 8, first, at Step 800, a spectrum from an internal wall of a vacuum chamber of the plasma process tool is obtained during a designated time period, wherein the spectrum from the internal wall of the vacuum chamber of the plasma process tool may be obtained by using, for example, a PDS, and the plasma process tool may include an HDP tool.

Next, at Step 810, the timing of open-chamber clean of the plasma process tool is determined based on decreases in the spectrum intensity of the obtained spectrum. As the operational time of the plasma process tool increases, the deposition film accumulated at the internal wall of the vacuum chamber of the plasma process tool correspondingly grows. Thereby, the timing of “open-chamber clean” of the plasma process tool can be determined by obtaining the spectrum from the internal wall of the vacuum chamber, such that the residual deposit film can be removed completely.

In view of the above, the apparatus of the present invention has the following features.

1. According to the present invention, the spectrum data may be obtained in real time and then analyzed, so as to monitor the plasma process and thereby ensure an optimal process condition of the plasma process.

2. According to the present invention, by monitoring a broadband spectrum from the plasma process, an abnormal plasma process condition that may damage a device can be determined and avoided.

3. The present invention may be applied to monitor the plasma process used for manufacturing a lot of chips by obtaining the spectrums of each chips, and any abnormal spectral characteristics may be detected and immediately corrected, so as to solve the problem within a short time and early prevent the issue during WAT. Thus, it is also possible to ensure optimal quality of the lot of chips with consistent reproducible result.

4. According to the present invention, the parameters (such as the reflection index, the value n and the value k) of the film deposited through a plasma process may be monitored and controlled according to the spectral variation.

5. According to the present invention, the damage to a semiconductor device during the plasma process due to an abnormal temperature of a chip can be detected.

6. The present invention may be applied to determine the timing of open-chamber clean of the plasma process tool, so as to schedule a cleaning in advance.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method of monitoring a plasma process tool, comprising:
obtaining a spectrum of a film to be detected from the plasma process tool; and
analyzing the spectrum by integrating a function of the spectrum intensity which focuses on a specific wavelength range to determine whether the spectrum is abnormal from a obtained value.

2. The method of monitoring a plasma process tool as claimed in claim 1, wherein the spectrum of the film to be detected is obtained utilizing a plasma detect system (PDS).

3. The method of monitoring a plasma process tool as claimed in claim 1, further comprising:
specifying a predetermined range for the plasma process tool in advance, wherein if the spectrum of the film to be detected is determined to be abnornal, the spectrum is regarded as not meeting the predetermined range; and
sending out a warning signal, after the spectrum has been analyzed to be abnormal.

4. The method of monitoring a plasma process tool as claimed in claim 1, further comprising a step of adjusting parameters of the plasma process tool if the spectrum is determined to be abnormal in the step of analyzing the spectrum.

5. The method of monitoring a plasma process tool as claimed in claim 1, wherein the plasma process tool includes a high density plasma (HDP) tool.

6. A method of protecting a semiconductor device from being damaged, comprising:
providing a plurality of films manufactured by a plasma process tool through different plasma processes, wherein the films are made of one material with a slightly different proportion of elements;
obtaining the spectrums of each of the films from the plasma process tool;
analyzing the spectrums of each of the films by comparing the spectrum intensity which focuses on a short wavelength range so as to determine a selected spectrum having a relatively low spectrum intensity compared to that of the remaining spectrums of each of the films; and
forming a film made of the material by using the plasma process corresponding to the selected spectrum.

7. The method of protecting a semiconductor device from being damaged as claimed in claim 6, wherein the selected spectrum has a lowest spectrum intensity compared to that of the remaining spectrums of each of the films.

8. The method of protecting a semiconductor device from being damaged as claimed in claim 6, wherein the spectrums of each of the films are obtained utilizing a PDS.

9. The method of protecting a semiconductor device from being damaged as claimed in claim 6, wherein the plasma process tool includes a HDP tool.

10. A method of monitoring the repeatability and stability of a lot of chips during a plasma process, comprising:
obtaining spectrums of the lot of chips from the plasma process tool; and
comparing the spectrums of the lot of chips, so as to monitor the stability and repeatability of the lot of chips.

11. The method of monitoring the repeatability and stability of a lot of chips during a plasma process as claimed in claim 10, wherein the step of comparing the spectrums of the lot of chips comprises:
selecting a wavelength range as the reference; and
comparing spectrum intensities of each chip of the lot of chips within the wavelength range.

12. The method of monitoring the repeatability and stability of a lot of chips during a plasma process as claimed in claim 10, wherein the lot of chips represent the chips being performed by the same program.

13. The method of monitoring the repeatability and stability of a lot of chips during a plasma process as claimed in claim 10, wherein the spectrums are obtained utilizing a PDS.

14. The method of monitoring a plasma process tool for ensuring a stability of plasma process conditions to produce a lot of chips with an optimal quality and with reproducible results as claimed in claim 10, wherein the plasma process tool includes an HDP tool.

15. A method of monitoring a film deposited through a plasma process, comprising:
providing a standard film;
obtaining a spectrum of the standard film;
performing a plasma process in a plasma process tool to deposit a film;
obtaining the spectrum of the film from the plasma process tool; and
comparing the spectrum of the film with that of the standard film and analyzing whether the film meets the standard film.

16. The method of monitoring a film deposited through a plasma process as claimed in claim 15, wherein if the standard film has a reflection index, a value n, and a value k within a predetermined range, and wherein when the film is determined not to meet the standard film, it is regarded as at least one of a reflection index or a value n and a value k of the film does not fall within the predetermined range.

17. The method of monitoring a film deposited through a plasma process as claimed in claim 15, wherein the spectrum of the standard film is obtained utilizing a PDS.

18. The method of monitoring a film deposited through a plasma process as claimed in claim 15, wherein the spectrum of the film is obtained utilizing a PDS.

19. The method of monitoring a film deposited through a plasma process as claimed in claim 15, wherein the plasma process tool includes an HDP tool.

20. A method of determining whether a semiconductor device is damaged during the plasma process, comprising:
providing a plurality of chips and forming a film to be detected on each of the chips respectively, wherein the film is manufactured in an identical plasma process tool through the same plasma process;
obtaining the spectrum of the film to be detected on each of the chips from the plasma process tool; and
comparing the spectrums of each of the film to be detected so as to find an abnormal spectrum, wherein the film to be detected having the abnormal spectrum is damaged during the plasma process due to an abnormal temperature of the chip.

21. The method of determining whether a semiconductor device is damaged as claimed in claim 20, wherein the spectrum of the film to be detected on each of the chips is obtained by using a PDS.

22. The method of determining whether a semiconductor device is damaged as claimed in claim 20, wherein the plasma process tool includes an HDP tool.

23. A method of determining a timing of open-chamber clean of a plasma process tool, comprising:
obtaining a spectrum from an internal wall of a vacuum chamber of the plasma process tool during a designated time period; and
determining the timing of open-chamber clean of the plasma process tool based on decreases in the spectrum intensity of the obtained spectrum.

24. The method of determining a timing of open-chamber clean of a plasma process tool as claimed in claim 23, wherein the process of obtaining the spectrum from the internal wall of the vacuum chamber of the plasma process tool is implemented by utilizing a PDS.

25. The method of determining a timing of open-chamber clean of a plasma process tool as claimed in claim 23, wherein the plasma process tool includes an HDP tool.

26. An apparatus for monitoring a plasma process tool, comprising:
a PDS, for obtaining a spectrum of a film to be detected from a plasma process tool; and
an analysis device, for receiving and analyzing the spectrum from the PDS to determine whether the film to be detected is abnormal.

27. The apparatus for monitoring a plasma process tool as claimed in claim 26, wherein the PDS at least comprises:
a broadband spectrum controller; and
an optical fiber, for transmitting a spectral signal of the film to be detected to the broadband spectrum controller.

28. The apparatus for monitoring a plasma process tool as claimed in claim 26, wherein the plasma process tool includes an HDP tool.

29. The apparatus for monitoring a plasma process tool as claimed in claim 26, wherein the analysis device includes a computer.
